(19) United States
(12) Patent Application Publication
(10) Pub. No.: US 2011/0316668 A1
(43) Pub. Date: Dec. 29, 2011

(54) Method and Apparatus to Facilitate Message Transmission and Reception Via Wireline Using Different Transmission Characteristics

(76) Inventors: Edward T. Laird, Lombard, IL (US); James J. Fitzgibbon, Batavia, IL (US)

(21) Appl. No.: 12/822,527

(22) Filed: Jun. 24, 2010

(51) Int. Cl. G06F 7/04; H04L 9/00

(52) U.S. Cl. 340/5.71; 380/255

(57) ABSTRACT

Upon providing (101) message content (such as a wireline remote control instruction) to be transmitted via wireline, and in conjunction with provision (102) of a plurality of different wireline transmission characteristics (as correspond, for example, to different types of wireline transmission) and a corresponding plurality of correlated recovery identifiers (103), a particular wireline transmission characteristic is selected (104) and used to transmit via wireline (105) a joint message. In particular, in a preferred approach, the selected wireline transmission characteristic (106) is used when transmitting via wireline at least a portion of the message content portion of the joint message while another part of the joint message carries the recovery identifier to thereby facilitate selection of an appropriate reception technique by a wireline receiver when receiving the joint message.

### RELATED APPLICATION(S)

This application is related to co-pending and co-owned U.S. patent application entitled METHOD AND APPARATUS TO FACILITATE WIRELINE TRANSMISSION OF AN ENCRYPTED ROLLING CODE, co-filed herewith and having attorney docket number 5569/97915 which is incorporated by reference in its entirety herein.

### TECHNICAL FIELD

This invention relates generally to message transmission and reception techniques and more particularly to the relatively secure conveyance of message contents.

### BACKGROUND

Various means of conveying messages are known in the art. In many cases an interest exists in preserving or otherwise maintaining at least some degree of security with respect to conveyance of the message. For example, in some cases it may be desired to prevent an eavesdropping party from gleaning the substantive content of the message. In other cases, as when the message comprises, at least in part, an instruction, command, or similar content it may be desirable to prevent an unauthorized party from effectively transmitting an unauthorized message in order to prevent instigation of unauthorized action by the receiving entity.

For example, movable barrier operators (such as but not limited to garage door openers) often respond to receipt of a wireless or wireline remote control signal. In particular, the movable barrier operator will often move a corresponding movable barrier between closed and opened positions in response to such wireless or wireline remote control signals. In such a case it often behooves the system operator to seek to ensure that the movable barrier operator will not respond to a wireless remote control signal when transmitted from an unauthorized wireless transmission source (where wireless remote control signals are typically viewed as being more susceptible to interception and analysis by unauthorized persons (using, for example, so-called code grabbers) than wireline transmissions).

In some cases the movable barrier operator expects to see a unique identifier or other code in conjunction with, or in lieu of, for example, a specific wireless remote control command. A prior approach provides at least some degree of security though a more sophisticated unauthorized party may be able to themselves receive such a wireless transmission and co-opt the identifier/code for their own future unauthorized use. With this in mind, so-called rolling codes are often employed to frustrate this approach to breaching the security of such a wireless system. With rolling codes, the code itself changes on a frequent basis pursuant to a plan (such as an implementing algorithm) known to both the wireless transmitter and the wireless receiver. Without knowledge of the underlying scheme by which a next code is selected, an unauthorized party who gains access to a presently used code or identifier will still remain unable to leverage that knowledge in support of effecting unauthorized control over the wireless receiver.

Such movable barrier operators also often respond to one or more other user interfaces that directly connect to the movable barrier operator via wireline (such as a pair of electrical conductors, a fiber optic cable, and so forth). These other user interfaces typically communicate with the movable barrier operator using an approach and/or protocol that is considerably simpler than the kinds of protocols that employ rolling codes as noted above. In some cases this may simply comprise monitoring the impedance states of the user interface. In other cases this may comprise relatively simple data transmissions conveying information regarding the user interface state(s). Typical movable barrier operators employ these kinds of approaches regardless of whether the movable barrier operator also employs a rolling-code based approach to protect the aforementioned wireless transmissions. This reflects, perhaps, the fact that wireline-based communications are already inherently better protected from eavesdropping and are not perceived as being likely to benefit from the use of a rolling code-based approach.

### BRIEF DESCRIPTION OF THE DRAWINGS

The above needs are at least partially met through provision of the method and apparatus to facilitate message transmission and reception using different transmission characteristics described in the following detailed description, particularly when studied in conjunction with the drawings, wherein:

FIG. 1 comprises a flow diagram as configured in accordance with various embodiments of the invention;

FIG. 2 comprises a schematic view of a data format as configured in accordance with various embodiments of the invention;

FIG. 3 comprises a schematic view of a data format as configured in accordance with various embodiments of the invention;

FIG. 4 comprises a schematic view of a data format as configured in accordance with various embodiments of the invention;

FIG. 5 comprises a schematic view of a data format as configured in accordance with various embodiments of the invention;

FIG. 6 comprises a flow diagram as configured in accordance with various embodiments of the invention;

FIG. 7 comprises a call flow diagram as configured in accordance with various embodiments of the invention;

FIG. 8 comprises a block diagram as configured in accordance with various embodiments of the invention; and

FIG. 9 comprises a block diagram as configured in accordance with various embodiments of the invention.

FIG. 10 comprises an illustrative example of an application in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, one provides a plurality of different transmission characteristics as each corresponds, for example, to various selectable types of transmission techniques or means. When message content exists to be transmitted (such as, but not limited to, a wireline remote control signal or wall control signal) a particular one of the transmission characteristics is selected and a corresponding recovery identifier that correlates to the selected transmission characteristic is selected as well. One then transmits a joint message comprising both the message content as is transmitted via wireline using the selected transmission characteristic and the recovery identifier as uniquely corresponds to the selected transmission characteristic.

Upon reception of the recovery identifier, and pursuant to a preferred approach, a particular way of receiving the wireline transmission of the message content portion of the joint message is selected as a function thereof and then used to facilitate reception of that message content portion.

The joint message can assume any of a wide variety of forms. For example, depending upon needs and/or requirements, the joint message can comprise a single contiguous message or can comprise a plurality of discrete wireline transmissions. The recovery identifier and the message content can be discrete with respect to one another or can, if desired, be at least partially integrated with one another.

These teachings are usable with a wide variety of different transmission characteristics and hence can provide benefits with a large number of platforms having transmission/reception agility of various kinds. It will also be seen that these teachings can be employed in conjunction with more traditional identifier/code based techniques including specifically rolling code-based techniques. So configured, security can be increased and often dramatically so. In particular, an unauthorized party will face increased difficulty with respect to viably monitoring the communications of such a system. An unauthorized party will also likely face increased difficulty with respect to accommodating and matching the transmission/reception agility of the resultant system.

The use of a rolling code-based approach in conjunction with wireline-based components is admittedly counterintuitive, given prior art practice in these regards. The applicant has determined, however, that such an approach can, in fact, prove advantageous in at least some application settings. As one example in these regards, the movable barrier operator now only needs a single and consistent approach to communicating with remote elements, regardless of whether those remote elements link to the movable barrier operator via wireless or wireline-based connections. This, in turn, can lead to reduced programming and design requirements, improved processing efficiencies, and corresponding cost reductions. As another example, such an approach can assist in assuring that an installer or end user does not inadvertently or intentionally connect a given movable barrier operator to a wireline remote component that may only be partially compatible with the operator and which might, over time, lead to inappropriate and unexpected behaviors on the part of the operator.

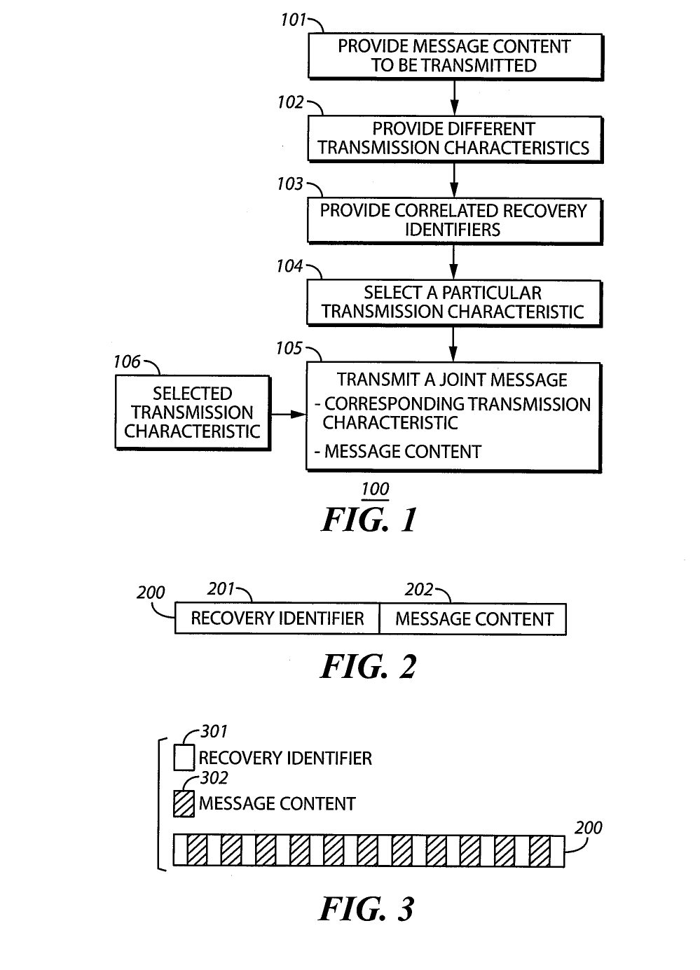

These and other benefits may become clearer upon making a thorough review and study of the following detailed description. Referring now to the drawings, and in particular to FIG. 1, an exemplary process 100 provides 101 message content to be transmitted (for example, from a wireline remote control device to a movable barrier operator where the message content comprises wall control signaling, an identifier for at least one of the wireline transmitting platform, the wireline receiving platform, the communication system to which one or more of these elements belongs, and/or a particular communication system user (such as an individual, a particular group of individuals, a business, or some other entity of interest)). In accordance with prior art practice this message content can also comprise, if desired, one or more rolling codes. Those skilled in the art will also understand that this message content can be encrypted, or not, in accordance with the needs and/or requirements of a given application setting.

This process 100 also provides for provision 102 of a plurality of different transmission characteristics. These transmission characteristics pertain to different types of transmission. Relevant examples comprise, but are not limited to:

a plurality of candidate transmission mediums (including but not limited to free space (including but not limited to air), metal conductors (including but not limited to single, twisted-pair and multi-pair wires, ribbon cables, multi and single-core conductors, coax, twin-ax and other various shielded cables, power transmission lines, cat5, cat6 and other various networking cables, 6-conductor, 8-conductor and other various telephone lines, Universal Serial Bus (USB), IEEE 1394 (FireWire) and other various serial bus interfaces cables, and so forth), optical conductors (including but not limited to optical fiber, photonic-crystal fiber and other various light-pipes), liquids (including but not limited to water), and so forth);

in the case of wireline transmission, a plurality of candidate transmission methods (including but not limited to synchronous and asynchronous serial transmission, parallel transmission, balanced or unbalanced line transmissions, common-mode differential, pseudo-differential and single-ended line transmissions, simplex, half-duplex and full-duplex transmissions, redundant line transmission, data bus transmissions, Local Area Network (LAN) transmission, Ethernet or Etherloop transmissions and so forth);

in the case of wireline transmission, a plurality of candidate transmission protocols (including but no limited to Transmission Control Protocol (TCP), Internet Protocol (IP), Internet Protocol Suite (TCP/IP), Datagram Congestion Control Protocol (DCCP), Digital Subscriber Loop (DSL), Integrated Services Digital Network (ISDN), Digital Signal 1 (T1) and other T-carriers, European Digital Signal 1 (E1) and other E-carriers, LAN, Recommended Standard 232 (RS-232), Recommended Standard 422 (RS-422), Recommended Standard 423 (RS-423), Recommended Standard 485 (RS-485), USB, FireWire, Musical Instrument Digital Interface (MIDI), Digital Multiplex Protocol (DMX), Peripheral Component Interconnect (PCI), Controller Area Network (CAN), International Telecommunications Union Telecommunications Standardization Sector (ITU-T) V-series standards, Synchronous Optical Network (SONET), Synchronous Digital Hierarchy (SDH), and so forth);

a plurality of candidate data rates;

a plurality of candidate spread spectrum practices (including but not limited to various spreading codes, frequency hopping patterns and/or usable (or unusable) channels, and so forth);

a plurality of candidate carrier modulations (including but not limited to frequency modulation, amplitude modulation, phase modulation, direct sequencing spread spectrum, frequency hopping spread spectrum, single sideband, vestigial sideband, and so forth);

a plurality of candidate carrier frequencies (including but not limited to specific center frequencies and corresponding information such as, but not limited to, channel width, guard band presence and/or width, and so forth);

a plurality of candidate joint message formats (including but not limited to integral formats, parsed formats, and so forth as will be described below in more detail);

a plurality of candidate data orders (where, for example, the order is changed for all remaining portions of the message, only a portion of the remaining message, or follows a pattern per message position);

a plurality of candidate data inversion patterns (where, for example, the inversion can be for the rest of the message, for a portion of the message, and/or follows a pattern per message position);

a plurality of candidate data symbols representing a data value (where, for example, the representation is modified for the whole message, a specific portion of the message, and/or follows a pattern per message position).

In a similar fashion this process 100 then further provides 103 for a correlated (or at least partially correlated) plurality of recovery identifiers (where, for example, a given recovery identifier correlates to and therefore essentially serves to identify a specific one of the transmission characteristics as was provided above). Accordingly, it will be understood that these recovery identifiers can comprise, but are not limited to:

particular transmission medium identifiers;

particular transmission method identifiers;

particular transmission protocol identifiers;

particular data rate identifiers;

particular spread spectrum practice identifiers;

particular carrier modulation identifiers;

particular carrier frequency identifiers;

particular joint message format identifiers;

particular data order identifiers;

particular data inversion pattern identifiers;

particular symbol pattern identifiers;

and so forth, to name but a few.

The recovery identifier can comprise, for example, a simple code where a specific value, such as a binary value, corresponds to a particular transmission characteristic. As a simplified example, when only two transmission characteristics are provided then a one-bit value will serve to identify these transmission characteristics. To illustrate, a value of “0” can correlate to a first transmission characteristic while a value of “1” can correlate to the second transmission characteristic. It would be possible, for example, for each recovery identifier to essentially point to a specific entry in a lookup table, where the specific entry itself defines the corresponding transmission characteristic.

If desired, the recovery identifier can share functionality and meaning in support of other content or capability. As an illustration, all or part of a rolling code can also serve as a recovery identifier. For example, and to continue the simple example presented above, the least significant bit of a rolling code can also serve to identify each of two provided transmission characteristics.

Pursuant to this process 100, one then selects 104 a particular one of the different transmission characteristics to thereby provide a selected transmission characteristic. This selection step 104 can be carried out in any of a wide variety of ways with a specific approach likely being dictated by the needs and/or limitations inherent to a given application context. As one example, the particular transmission characteristic can be selected essentially at random. As another example the particular transmission characteristic can be selected pursuant to a pre-selected selection pattern. The selection itself can be the result of a specific selection process or can be a part of another process (as when the particular transmission characteristic selected is dependent upon the least significant bit (or bits) of a rolling code as is derived via its own derivation process).

This process 100 then facilitates the transmission via wireline 105 of a joint message that comprises at least the recovery identifier as uniquely corresponds to the selected transmission characteristic and the previously provided message content. In a preferred approach, at least the message content portion of the joint message is transmitted using the selected transmission characteristic 106.

There are various useful ways to deploy these teachings. For example, and referring now to FIG. 2, a given joint message 200 can comprise a first portion (such as a first field) that comprises the recovery identifier 201 and a second portion (such as a second field) that comprises the message content 202 where the first and second portion comprise an essentially continuous aggregation of the recovery identifier 201 and the message content 202. When so aggregated, if desired, the two portions or fields can be essentially discrete from one another as suggested by the schematic illustration provided in FIG. 2. If desired, however, these portions can be interleaved with one another as is suggested and shown in FIG. 3. In this illustrative example, small portions comprising parts of the recovery identifier 301 and the message content 302 are interleaved with one another. This interleaving can comprise a symmetrical pattern (as is suggested by the illustration provided) or can be effected using any other pattern or interleaving criteria of choice.

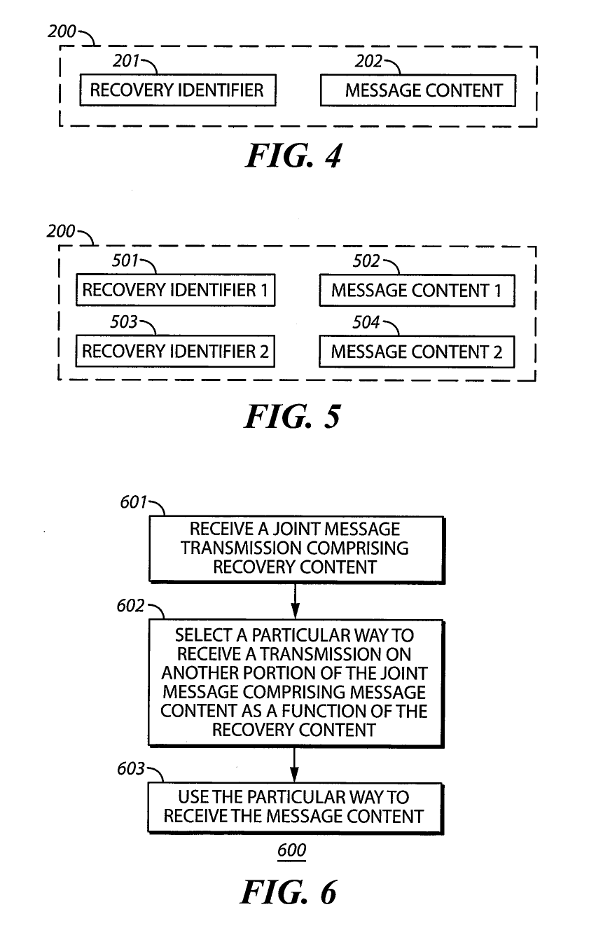

In the illustrative examples provided above, the recovery identifier and the message content are aggregated with one another. It is also possible, however, for the joint message 200 to comprise a plurality of discrete messages as is suggested by the schematic depiction of FIG. 4. In this example the recovery identifier 201 is separate and distinct from the message content 202. The nature of this separation can vary with the needs and/or limitations of a given application setting. Useful examples include, but are not limited to, separation by time (as when the individual joint message portions are sent at considerably different times), carrier characteristics (as when the individual joint message portions are sent using different transmission characteristics as pertain to the carrier), specific bit patterns, and/or a specific quantity of bits.

The approaches described above can be further parsed and combined in various ways if desired. As but one illustration of many possibilities, and referring now to FIG. 5, the message content can itself be parsed into a first message content portion 502 and a second message content portion 504. In turn, the first message content portion 502 can be sent using a first corresponding transmission characteristic that is identified by a corresponding first recovery identifier 501 and the second message content portion 504 can be sent using a second corresponding transmission characteristic that is identified by a corresponding second recovery identifier 503. These various informational elements can, in turn, be aggregated or separated as described above to form the corresponding joint message 200.

Referring now to FIG. 6, a corresponding receive process 600 preferably begins with reception via wireline 601 of a joint message (such as those described above) comprising, at least in part, the recovery content (that is, reception of the recovery content portion (or at least a portion thereof) may precede reception of at least part of the message content portion in order to enable use of the recovery content portion to facilitate proper reception of that message content portion). This process 600 then facilitates selection 602 of a particular way of receiving via wireline a transmission of another portion of that joint message (which portion comprises, for example, at least a portion of the message content).

In a preferred approach this selection 602 occurs as a function, at least in part, of the recovery content as has already been received. To illustrate, when the recovery content comprises data that correlates to a first transmission characteristic (as was described above) then a way of receiving as corresponds to that first transmission characteristic can be selected. Similarly, when the recovery content comprises data that correlates to a second transmission characteristic then another way of receiving, which corresponds to that second transmission characteristic, can be selected. This process 600 then uses 603 that selected particular way of receiving to facilitate proper reception of that portion of the joint message as comprises at least a portion of the message content.

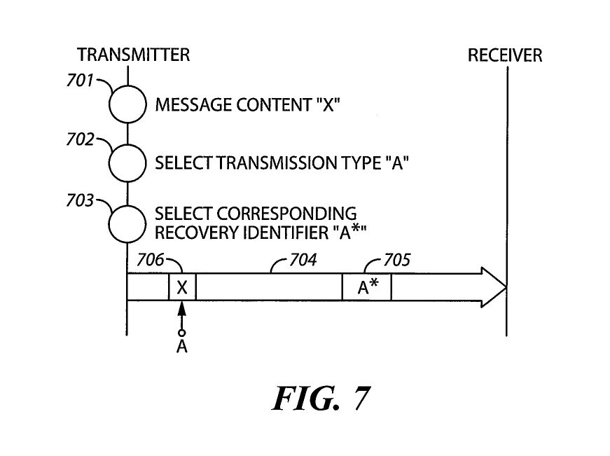

FIG. 7 illustrates one way by which these teachings can be employed. In this illustrative example, a wireline transmitter develops (or otherwise detects a need to transmit already available) message content that is denoted here by the letter “X.” 701. In this example, the wireline transmitter then selects a particular transmission type 702 (denoted here by the letter “A”) and the recovery identifier 703 (denoted here by the letter “A*”) which corresponds thereto. The wireline transmitter then transmits via wireline a joint message 704 to a receiver, which joint message 704 includes both the recovery identifier “A*” 705 and the message content “X” 706. And, as per these teachings, at least a portion of the joint message 704 as comprises a portion of the message content 706 is transmitted as per the dictates of the selected transmission type “A.”

Upon receiving via wireline that portion of the joint message 704 as comprises the recovery identifier “A*” 705, the wireline receiver can employ that information to identify and select the appropriate reception settings that permit compatible reception of that portion of the joint message 704 as comprises, at least in part, at least a part of the message content “X” 706.

So configured, a considerable increase in security occurs. In particular, it becomes increasingly difficult for an unauthorized party to spoof the wireline receiver as mere data alone is insufficient to cause proper reception of the message content. Instead, considerable agility and flexibility with respect to types of transmission must also be supported.

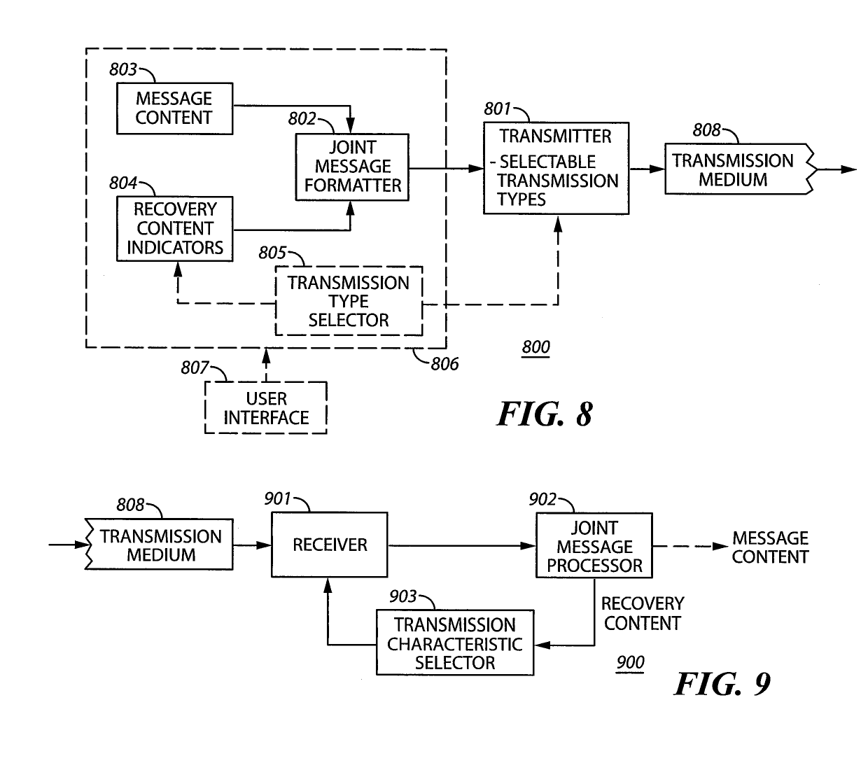

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 8, an illustrative approach to a particular transmission platform will be provided.

This transmission platform 800 comprises a transmitter 801 that is preferably capable of various selectable types of transmission through various transmission mediums 808 (including, but not limited to, wireline transmission mediums) where, as described above, these various selectable types of transmission differ from one another as a function, at least in part, of corresponding transmission characteristics (including, but not limited to, wireline transmission characteristics). In a preferred approach a single dynamically configurable transmitter serves this purpose. If desired, however, the transmitter 801 can comprise a plurality of discrete transmitters, wireless or wireline type, that differ from one another in the indicated manner. In a preferred embodiment this transmitter 801 comprises a wireline transmitter.

This transmission platform 800 preferably further comprises a joint message formatter 802 having an input that operably couples to receive message content 803 (as may be stored, for example, in a memory) and another input that operably couples to receive a selected recover content indicator 804 (as may be stored, for example, in another memory). So configured, the joint message formatter 802 serves to format and otherwise provide the joint message described above. If desired, this transmission platform 800 can further comprise a transmission type selector 805 that operably couples to both the recovery content indicators 804 (to facilitate selection of a particular one of the stored indicators) and the transmitter 801 (to facilitate selection of a particular type of transmission to be used when conveying the message content portion of the joint message).

The above-described elements can comprise discrete components if desired. It is also possible, however, to view the transmission platform 800 presented in FIG. 8 as a logical view where one or more of these elements are realized via shared facilities. For example, it may be useful for many applications to use a wholly or partially programmable platform such as a microprocessor 806 to effect the described functionality. It may also be useful, at least in some application settings as when the transmission platform 800 comprises a wireline remote control for a movable barrier operator, to further provide for a user interface 807 (such as, but not limited to, one or more user-assertable buttons, switches, keys, a touch screen, or the like). Such an interface can serve, for example, as a triggering mechanism to begin the described processes.

Referring now to FIG. 9, an illustrative approach to a particular reception platform will be provided. In this illustrative embodiment the reception platform 900 comprises a receiver 901 (for example, a wireline receiver) that is preferably capable of receiving various selectable types of transmissions from various transmission mediums 808 wherein these selectable types of transmissions differ from one another as a function, at least in part, of corresponding transmission characteristics as have been presented above. As with the above-described transmitter, this receiver 901 can comprise a single selectively agile platform in this regard or can itself be comprised of a plurality of discrete receivers, wireless or wireline type, that each support some, but not all, of the selectable types of transmission. In a preferred embodiment this receiver 901 comprises a wireline receiver. Pursuant to these teachings, this receiver 901 is configured and arranged to facilitate compatible reception of a joint message such as those described herein.

This receiver 901 operably couples to a joint message processor 902 which extracts the recovery content and message content as described above from a received joint message. The recovery content, in turn, is provided to a transmission characteristic selector 903 which in turn selects, in this embodiment, a particular transmission characteristic and hence a particular type of reception technique to be employed to facilitate compatible reception of the message content portion of the joint message.

So configured, a transmitter and a corresponding receiver can each readily support the teachings set forth herein. In particular, a plurality of differing types of transmission are selectively usable to effectively encode (in a manner of speaking) message content to be conveyed between the transmitter and the receiver (which message content may comprise, for example, an instruction to be carried out via the receiver). The receiver determines a particular type of reception to employ when receiving the transmission of the message content based, at least in part, upon a recovery indicator that also comprises a part of the overall message.

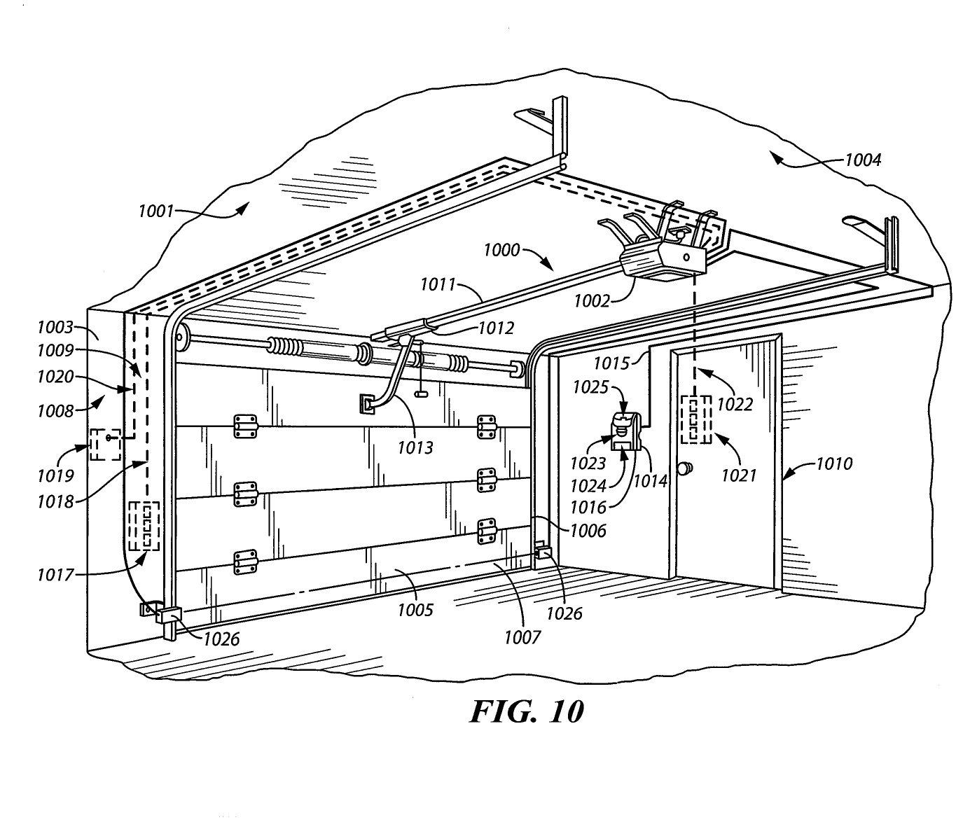

Referring now to FIG. 10, it may be helpful to describe an illustrative application setting. It will be understood that the specifics of this example are intended to serve only in an illustrative regard and are not intended to express or suggest any corresponding limitations with respect to the scope of these teachings.

In this illustrative example, a barrier movement controller 1000 comprises, in part, various garage and garage door elements 1001, such as a garage door operator 1002 positioned within a garage 1003. This garage door operator 1002 mounts to the garage ceiling 1004 and serves to control and effect selective movement of a multipanel garage door 1005. The multipanel garage door 1005 includes a plurality of rollers (not shown) rotatably confined within a pair of tracks 1006 positioned adjacent to and on opposite sides of the garage opening 1007. The garage 1003 also has internal 1008 and external wall surfaces 1009. The garage 1003 may also have one or more utility doors 1010 (it being understood that a “utility door” serves to provide a human being of at least average height, weight, and physical ability with a selectively closeable and openable pathway by which this person can personally exit the garage and/or gain entry to the garage other than via the aforementioned garage door).

The garage door operator 1002 includes a head unit have a motor (not shown) to provide motion to the garage door 1005 via a rail assembly 1011. The rail assembly 1011 includes a trolley 1012 for releasable connection of the head unit to the garage door 1005 via an arm 1013. The arm 1013 connects to an upper portion of the garage door 1005. The trolley 1012 connects to an endless chain (or belt or the like) (not shown) that effects the desired movement of the trolley 1012 and hence the door 1005 via the arm 1013. This chain can be driven by a sprocket (not shown) that couples to the aforementioned motor in the head unit.

The barrier movement controller 1000 may include at least one transmission platform 800 (which may or may not also include at least one reception platform 900) comprising a wireline control unit 1014 immovably or semi-movably affixed, when properly installed as per the intentions and instructions of the manufacturer, to a surface of the garage 1003, such as the garage ceiling 1004, internal wall surfaces 1008, or external wall surfaces 1009, or to any of the various garage and garage door elements 1001. The wireline control unit 1014 is operably connected to the garage door operator 1002 via a wireline 1015 (as used herein, this reference to “wireline” will be understood to refer to one or more solid electrical conductors (including both single wire and multiple wire configurations, solid light-bearing carriers (such as optical fibers), and so forth).

By way of a particular example, the wireline control unit 1014 may comprise a wall control unit 1016 affixed to an internal wall surface 1008 of the garage 1003 (preferably, but not necessarily, near a utility door 1010 possibly leading to a main building attached to the garage 1003 or to the exterior of the garage 1003). Optionally, in lieu of or in addition to the aforementioned wall control unit 1016, another wall control unit 1017 may be affixed to an interior wall surface 1008 located near the garage door 1005, which is also connected via another wireline 1018 to the garage door operator 1002. Additionally, in lieu of or in addition to the aforementioned wall control units 1016 and 1017, yet another wireline control unit 1019 may be affixed to an exterior wall surface 1009 located near the garage door 1005 and operably connected to the garage door operator via yet another wireline 1020. Optionally, a vertically-suspended wireline control unit 1021 may be connected to the garage door operator 1002 by yet another wireline 1022 and suspended from the ceiling 1004, the garage door operator 1002, or any other garage and garage door element 1001 by a supportive mechanism such as a rope, a chain, or the wireline 1022 itself.

The wireline control unit 1014 may comprise a housing made of plastic, metal, or other suitable materials, and one or more buttons or switches 1023 operably associated with one or more functions of the barrier movement controller 1000 and that are readily accessible to an end user seeking to physically interact with such buttons/switches. These buttons 1023 may comprise any variety of button types, including mechanical and electrical buttons as are known in the art. Alternatively, these buttons may be embodied on a touch screen. These buttons 1023 may, for example, comprise a single toggle button to effectuate opening and closing of the garage door 1005, or to stop the garage door operator 1002 during operation. Alternatively, various barrier movement controller 1002 functions can be assigned to multiple buttons (for example, one button for “UP,” one button for “DOWN,” and one button for “STOP”). Alternatively, the buttons 1023 may comprise a keypad a user employs to input codes to effectuate functions of the barrier movement controller 1000.

By yet another approach, the wireline control unit 1014 may comprise, in lieu of or in addition to the aforementioned buttons 1023, one or more alternate mechanisms for user interaction with the wireline control unit 1024 (such as a biometric scanner (including fingerprint and retinal scanners), a radio frequency identifier (RFID) reader, or a voice recognition module). In addition to controlling movement of the garage door 1005, other functions of the barrier movement controller 130 may be assigned to any of the one or more buttons 1023 or alternate mechanisms for user interaction 1024 (resulting in, for example, a light toggle button, a lockout button, a programming button, and so forth).

In various embodiments, the wireline control unit 1014 may include a display 1025 that may or may not be illuminated. This display 1025 may also contain the aforementioned touch-screen capabilities. The wireline control unit 1014 may be powered by any methods of choice known in the art, including external or internal power supplies, battery, solar power, or even power derived from the garage door operator 1002 through the wireline 1015, 1018, 1020, 1022.

The head unit may also include a radio frequency receiver (not shown) having an antenna (not shown) to facilitate receiving coded radio frequency transmissions from one or more wireless radio transmitters (not shown). These wireless transmitters may include portable wireless transmitters (such as keyfob-style transmitters) or wireless keypad transmitters (such as those often installed in automobile sun visors). The radio receiver typically connects to a processor in the head unit that interprets received signals and responsively controls other portions of the garage door operator 1002.

In addition, in this illustrative example the barrier movement controller 1002 includes an obstacle detector 1026 that optically or via an infrared-pulsed beam detects when the garage door opening is blocked and signals the garage door operator 1002 accordingly of the blockage. The aforementioned processor can then, for example, cause a reversal or opening of the door 1005 to avoid contact with the obstacle.

So configured, those skilled in the art will recognize and appreciate that these teachings offer great flexibility and opportunity with respect to further protecting information during a wireline transmission of that information. These teachings have particular relevance to transmissions of rolling codes and offer particular advantages when also used in conjunction with the transmission of fixed information in addition to rolling code information. The particular transmission characteristics presented are largely compatible for use with a wide variety of wireline modulation techniques, mediums, methods, and protocols. Those skilled in the art will also appreciate that these teachings are highly compatible for use with binary-based representations of ternary data formats.

So configured, a given movable barrier operator, using a single protocol, can successfully communicate with both wireless and wireline-based user interfaces. These teachings will readily support using fixed codes and/or rolling codes to permit the movable barrier operator to readily identify and distinguish these various user interfaces from one another. These teachings are highly scalable and can be employed in conjunction with a wide variety of movable barrier operators and/or application settings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing message content to be transmitted via wireline;
providing a plurality of different transmission characteristics;
providing recovery identifiers wherein at least a portion of a given recovery identifier correlates to a given corresponding one of the plurality of different transmission characteristics;
selecting a particular one of the different transmission characteristics to provide a selected transmission characteristic;
transmitting via wireline a joint message comprising:
the recovery identifier as uniquely corresponds to the selected transmission characteristic;
the message content;
wherein at least a portion of the joint message as comprises the message content is transmitted using the selected transmission characteristic, and wherein the joint message is configured to allow a receiver to configure itself according to the selected transmission characteristic correlated to the recovery identifier and the recovery identifier therefore allows the receiver to receive the message content.

2. The method of claim 1 wherein the message content comprises wall control signaling.

3. The method of claim 1 wherein providing a plurality of different transmission characteristics comprises providing at least one of:
a plurality of candidate data rates;
a plurality of candidate spread spectrum practices;
a plurality of candidate carrier modulations;
a plurality of candidate carrier frequencies;
a plurality of candidate joint message formats;
a plurality of candidate data orders;
a plurality of candidate data inversion patterns.

4. The method of claim 1 wherein providing recovery identifiers comprises providing at least one of:
a particular transmission medium identifier;
a particular transmission method identifier;
a particular transmission protocol identifier;
a particular data rate identifier;
a particular spread spectrum practice identifier;
a particular carrier modulation identifier;
a particular carrier frequency identifier;
a particular joint message format identifier;
a particular data order identifier;
a particular data inversion pattern identifier.

5. The method of claim 1 wherein transmitting via wireline the joint message comprises transmitting via wireline a contiguous aggregation of the message content and the recovery identifier as uniquely corresponds to the selected transmission characteristic.

6. The method of claim 5 wherein the joint message further comprises at least a first field comprising the message content and a second field comprising the recovery identifier.

7. The method of claim 6 wherein the first field and second field are discrete with respect to one another.

8. The method of claim 6 wherein the first field and the second field are at least partially interleaved with one another.

9. The method of claim 1 wherein transmitting via wireline a joint message comprises transmitting via wireline a plurality of discrete messages.

10. The method of claim 9 wherein the plurality of discrete messages are separated from one another by at least one of:
time;
carrier characteristics;
specific bit patterns
specific quantity of bits.

11. The method of claim 1 wherein the message content comprises, at least in part, an identifier for at least one of:
a transmitting platform;
a receiving platform;
a communication system;
a communication system user.

12. An apparatus comprising:
message content;
a wireline transmitter capable of various selectable types of wireline transmission, wherein the various selectable types of wireline transmission differ from one another as a function, at least in part, of corresponding wireline transmission characteristics, and wherein the wireline transmitter is configured to transmit a joint message with the message content transmitted according to a selected at least one of the wireline transmission characteristics and with at least one specific recovery content indicator transmitted according to at least one different wireline transmission characteristic;
a plurality of recovery content indicators wherein each of the recovery content indicators has at least a portion thereof that corresponds to a given corresponding one of the wireline transmission characteristics;
a joint message formatter having an input operably coupled to the message content and to the plurality of recovery content indicators and having a joint message output operably coupled to the transmitter and comprising both the message content and the at least one specific recovery content indicator as corresponds to a presently selected at least one of the wireline transmission characteristics.

13. The apparatus of claim 12 wherein the specific recovery content indicator comprises a portion of the message content.

14. The apparatus of claim 12 wherein the message content comprises wall control signaling.

15. The apparatus of claim 12 wherein the wireline transmission characteristics comprise at least one of:
a plurality of candidate transmission mediums;
a plurality of candidate transmission methods;
a plurality of candidate transmission protocols;
a plurality of candidate data rates;
a plurality of candidate conversion symbol sets;
a plurality of candidate spread spectrum practices;
a plurality of candidate carrier modulations;
a plurality of candidate bit inversion patterns;
a plurality of candidate carrier frequencies;
a plurality of candidate bit interleaving patterns;
a plurality of candidate bit patterns.
a plurality of candidate joint message formats.

16. The apparatus of claim 12 wherein the recovery content indicator comprises at least one of:
a particular transmission medium identifier;
a particular transmission method identifier;
a particular transmission protocol identifier;
a particular symbol conversion set identifier;
a particular spread spectrum practice identifier;
a particular carrier modulation identifier;
a particular bit inversion pattern identifier;
a particular carrier frequency identifier;
a particular bit interleaving pattern identifier;
a particular bit pattern identifier;
a particular joint message format identifier;
a particular data order identifier.

17. The apparatus of claim 12 wherein the joint message output comprises a contiguous combination of the message content and the specific recovery content indicator.

18. The apparatus of claim 17 wherein the joint message output further comprises at least a first field comprising the message content and a second field comprising the specific recovery content indicator.

19. The apparatus of claim 18 wherein the first field and second field are discrete with respect to one another.

20. The apparatus of claim 18 wherein the first field and the second field are at least partially interleaved with one another.

21. The apparatus of claim 12 wherein the joint message output comprises a plurality of discrete messages.

22. A method comprising:
receiving a transmission via wireline of a joint message comprising, in part, recovery content wherein the recovery content is received in a first particular way;
selecting a second particular way of receiving a transmission via wireline of another portion of the joint message comprising message content as a function, at least in part, of the recovery content;
using the second particular way to receive via wireline that portion of the joint message that comprises the message content.

23. The method of claim 22 wherein receiving a transmission via wireline of a joint message comprises receiving via wireline a single contiguous message.

24. The method of claim 22 wherein receiving a transmission via wireline of a joint message comprises receiving via wireline a plurality of discrete transmissions.

25. The method of claim 22 wherein the message content comprises wall control signaling.

26. The method of claim 22 wherein the particular way comprises at least one of:
selecting a particular transmission medium from amongst a plurality of candidate transmission mediums;
selecting a particular transmission method from amongst a plurality of candidate transmission methods;
selecting a particular transmission protocol from amongst a plurality of candidate transmission protocols;
selecting a particular data rate from amongst a plurality of candidate data rates;
using a particular set of conversion symbols as selected from amongst a plurality of candidate sets;
selecting a particular spread spectrum practice from amongst a plurality of candidate sets;
selecting a particular carrier demodulation from amongst a plurality of candidate carrier demodulations;
selecting a particular bit inversion pattern from amongst a plurality of candidate patterns;
selecting a particular carrier frequency from amongst a plurality of candidate carrier frequencies;
selecting a particular bit de-interleaving pattern from amongst a plurality of candidate patterns;
selecting a particular joint message format from amongst a plurality of candidate formats;
selecting a particular data inversion patterns from amongst a plurality of candidate patterns

27. The method of claim 22 wherein the recovery content comprises at least one of:
a transmission medium identifier;
a transmission method identifier;
a transmission protocol identifier;
a symbol conversion set identifier;
a spread spectrum practice identifier;
a carrier demodulation identifier;
a bit inversion pattern identifier;
a carrier frequency identifier;
a bit de-interleaving pattern identifier;
a joint message format identifier;
a data pattern inversion pattern identifier.

28. The method of claim 22 wherein receiving a transmission via wireline of a joint message comprises receiving a transmission via wireline of a joint message wherein the joint message comprises at least a first field comprising the message content and a second field comprising the recovery content.

29. The method of claim 28 wherein the first field and second field are discrete with respect to one another.

30. The method of claim 28 wherein the first field and the second field are at least partially interleaved with one another.

31. The method of claim 28 wherein receiving a transmission via wireline of a joint message comprises receiving a plurality of wireline-transmitted messages that comprise, when aggregated, the joint message.

32. The method of claim 31 wherein the plurality of wireline-transmitted messages are separated from one another by at least one of:
time;
carrier characteristics
specific bit patterns.

33. The method of claim 22 wherein the message content comprises, at least in part, an identifier for at least one of:
a wireline transmitting platform;
a wireline receiving platform;
a communication system;
a communication system user.

34. An apparatus comprising:
a wireline receiver capable of receiving via wireline various selectable types of wireline transmissions, wherein the various selectable types of wireline transmission differ from one another as a function, at least in part, of corresponding wireline transmission characteristics, and wherein the wireline receiver is configured to receive via wireline a portion of a joint message as comprises message content using a selected one of the various selectable types of wireline transmissions;
a wireline transmission characteristic selector operably coupled to a control input of the receiver, wherein the wireline transmission characteristic selector is responsive to a recovery content input such that the wireline transmission characteristic selector configures the wireline receiver according to recovery content within the joint message;
a joint message processor operably coupled to the wireline receiver and to the recovery content input of the wireline transmission characteristic selector, wherein the joint message processor is configured to extract recovery content from the joint message

35. The apparatus of claim 34 wherein the message content comprises wall control signaling.

36. The apparatus of claim 34 wherein the wireline transmission characteristics comprise at least one of:
a plurality of candidate transmission mediums;
a plurality of candidate transmission methods;
a plurality of candidate transmission protocols;
a plurality of candidate data rates;
a plurality of candidate conversion symbol sets;
a plurality of candidate spread spectrum practices;
a plurality of candidate carrier modulations;
a plurality of candidate bit inversion patterns;
a plurality of candidate carrier frequencies;
a plurality of candidate bit interleaving patterns;
a plurality of candidate bit patterns.
a plurality of candidate joint message formats.

37. The apparatus of claim 34 wherein the recovery content comprises at least one of:
a particular transmission medium identifier;
a particular transmission method identifier;
a particular transmission protocol identifier;
a particular symbol conversion set identifier;
a particular spread spectrum practice identifier;
a particular carrier modulation identifier;
a particular bit inversion pattern identifier;
a particular carrier frequency identifier;
a particular bit interleaving pattern identifier;
a particular bit pattern identifier;
a particular joint message format identifier;
a particular data order identifier.

38. The apparatus of claim 34 wherein the wireline receiver comprises means for receiving a transmission via wireline of a joint message comprising at least a first field comprising the message content and a second field comprising the recovery content.

39. The apparatus of claim 38 wherein the first field and second field are discrete with respect to one another.

40. The apparatus of claim 38 wherein the first field and the second field are at least partially interleaved with one another.

41. The apparatus of claim 38 wherein the transmission via wireline of a joint message comprises a plurality of wireline-transmitted messages that comprise, when aggregated, the joint message.

42. The apparatus of claim 41 wherein the plurality of wireline-transmitted messages are separated from one another by at least one of:
time;
carrier characteristics;
specific bit patterns.

43. The apparatus of claim 34 wherein the message content comprises, at least in part, an identifier for at least one of:
a wireline transmitting platform;
a wireline receiving platform;
a communication system;
a communication system user.

44. A method for use with a wireline receiver that is configured and arranged to compatibly receive and process a wireline-transmitted joint message, wherein:
at least a portion of the joint message comprises message content that is wireline-transmitted using a selected wireline transmission characteristic as has been selected from amongst a plurality of different wireline transmission characteristics;
as least a portion of the joint message comprises a recovery identifier that is wireline-transmitted using a different wireline transmission characteristic, wherein the recovery identifier uniquely corresponds to the selected wireline transmission characteristic;
the method comprising:
at a wireline transmitter:
providing a message that will be compatibly received and processed by the wireline receiver as the wireline-transmitted joint message;
transmitting the message via wireline to the wireline receiver.

45. The method of claim 44 wherein transmitting the message via wireline to the wireline receiver comprises serially transmitting data elements as comprise the message.

46. The method of claim 45 wherein serially transmitting the data elements as comprise the message comprises serially transmitting the data elements via a wireline connection from a wall control unit.

47. A method comprising:
providing message content to be transmitted via wireline;
providing a plurality of different wireline transmission characteristics from the group consisting of at least one of a particular data order or a particular data inversion pattern;
providing recovery identifiers wherein at least a portion of a given recovery identifier correlates to a given corresponding one of the plurality of different wireline transmission characteristics, and wherein the recovery identifiers comprise at least one of a particular data order identifier or a particular data inversion pattern identifier;
selecting a particular one of the different wireline transmission characteristics to provide a selected wireline transmission characteristic;
transmitting via wireline a joint message comprising:
the recovery identifier as uniquely corresponds to the selected wireline transmission characteristic;
the message content;
wherein at least a portion of the joint message as comprises the message content is transmitted using the selected wireline transmission characteristic.

48. A movable barrier remote control wireline transmitter comprising:
message content;
a wireline transmitter configured to communicate with a movable barrier operator, and capable of various selectable types of wireline transmission, wherein the various selectable types of wireline transmission differ from one another as a function, at least in part, of corresponding wireline transmission characteristics, and;
a plurality of recovery content indicators wherein each of the recovery content indicators has at least a portion thereof that corresponds to a given corresponding one of the wireline transmission characteristics;
a joint message formatter having an input operably coupled to the message content and to the plurality of recovery content indicators and having a joint message output operably coupled to the wireline transmitter and comprising both the message content and the at least one specific recovery content indicator as corresponds to a presently selected at least one of the wireline transmission characteristics.

49. The movable barrier remote control wireline transmitter of claim 48, wherein the wireline transmitter is configured to transmit via wireline the message content according to the wireline transmission characteristic selected for the message content and to transmit via wireline at least one specific recovery content indicator according to at least one wireline transmission characteristic that is different from the wireline transmission characteristic that is selected for the message content.
